(19) United States
(12) Patent Application Publication
(10) Pub. No.: US 2024/0422579 A1
(43) Pub. Date: Dec. 19, 2024

(54) WIRELESS NETWORK OPTIMIZATION

(71) Applicant: INTERNATIONAL BUSINESS MACHINES CORPORATION, ARMONK, NY (US)

(72) Inventors: NAOTO ITO, Bunkyo-ku (JP); Shuhei Kochi, Tokyo (JP); KENICHI YOKOMIZO, Tokyo (JP); Kohichiroh Nishiue, Chiba (JP)

(21) Appl. No.: 18/337,145

(22) Filed: Jun. 19, 2023

(51) Int. Cl. H04W 24/02; H04L 43/0817; H04W 4/38; H04W 24/10

(52) U.S. Cl. CPC H04W 24/02; H04L 43/0817; H04W 4/38; H04W 24/10

(57) ABSTRACT

A method, computer system, and a computer program product for network optimization is provided. The present invention may include moving a sensor in a three-dimensional space. The present invention may also include collecting, using the sensor, network performance data in a plurality of locations in the three-dimensional space. The present invention may further include detecting, based on the network performance data, at least one location of the plurality of locations including below-threshold network performance. The present invention may further include predicting at least one root cause for the below-threshold network performance at the at least one location.

### BACKGROUND

The present invention relates generally to the field of computing, and more particularly to wireless communication networks.

Wireless network performance is crucial to meet the demands of modern communication and technologies. Slow or unreliable wireless networks may decrease productivity, stall business operations, and negatively impact the overall user experience. The performance of a wireless network is directly linked to the propagation of wireless signals, which may be difficult to monitor and optimize in real-time.

### SUMMARY

Embodiments of the present invention disclose a method, computer system, and a computer program product for network optimization. The present invention may include moving a sensor in a three-dimensional space. The present invention may also include collecting, using the sensor, network performance data in a plurality of locations in the three-dimensional space. The present invention may further include detecting, based on the network performance data, at least one location of the plurality of locations including below-threshold network performance. The present invention may further include predicting at least one root cause for the below-threshold network performance at the at least one location.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computing environment according to at least one embodiment;

FIG. 2 is a schematic block diagram of a network optimization environment according to at least one embodiment;

FIG. 3 is a schematic block diagram of a network optimization graphical user interface according to at least one embodiment; and

FIG. 4 is an operational flowchart illustrating a process for network optimization according to at least one embodiment.

### DETAILED DESCRIPTION

The following described exemplary embodiments provide a system, method, and computer program product for wireless network optimization. As such, the present embodiment has the capacity to improve the technical field of wireless communication networks by providing a visualization of real-time wireless network availability and unavailability in a three-dimensional space, including predicted root cause, and troubleshooting for any wireless network unavailability. More specifically, a network optimization program may implement a sensor to autonomously move throughout a three-dimensional space and collect network performance data in a plurality of locations in the three-dimensional space. The network optimization program may detect at least one location in the three-dimensional space that includes below-threshold network performance (e.g., slow wireless network) based on the network performance data. The network optimization program may predict a root cause for the below-threshold network performance and provide troubleshooting steps to improve the network performance. The network optimization program may construct a map of the three-dimensional space to visualize the network performance in the three-dimensional space. The map may display any locations with below-threshold network performance, the predicted root cause for the below-threshold network performance, and troubleshooting steps to improve the network performance.

As described previously, wireless network performance is crucial to meet the demands of modern communication and technologies. Slow or unreliable wireless networks may decrease productivity, stall business operations, and negatively impact the overall user experience. The performance of a wireless network is directly linked to the propagation of wireless signals, which may be difficult to monitor and optimize in real-time. Optimizing the propagation of wireless signals may be especially difficult in previously unknown environments where new variables (e.g., physical obstructions, density of electronic devices, location of wireless access points) may impact wireless network performance.

Therefore, it may be advantageous to, among other things, provide a way to autonomously capture and analyze wireless signals. It may also be advantageous to provide a graphical user interface (GUI) that can visualize the wireless signal quality in a three-dimensional space and indicate any locations with weak wireless signals, resulting in below-threshold network performance. It may further be advantageous to predict the root cause for the below-threshold network performance, and provide troubleshooting steps to improve the network performance.

According to one embodiment, the network optimization program may implement an autonomously moving sensor such as, for example, a drone or other autonomous or unmanned vehicle (UV) to map the wireless communication speeds in a three-dimensional space. In one embodiment, the moving sensor may be equipped with a wireless network analyzer, one or more cameras, and other measurement devices to capture network performance data, visual data, and location data. The network optimization program may combine the data captured by the moving sensor to generate a visual map of the wireless network performance in the three-dimensional space and predict the root causes for poor network performance. The data may be captured automatically by the moving sensor in real-time, without human intervention (e.g., a user walking around the three-dimensional space to measure the wireless network performance in various locations of the space). In one embodiment, the network optimization program may implement the moving sensor in an indoor space (e.g., office building) where global positioning system (GPS) data may be unavailable for navigation.

According to one embodiment, a UV may autonomously patrol (e.g., via air and/or ground) an indoor space and simultaneously capture network performance data, visual data, and location data using various onboard sensors (e.g., wireless network analyzers, cameras, light detection and ranging (Lidar) sensors, depth sensors, inertial sensors). The UV may capture a video of the indoor space and measure the wireless signal (e.g., Wi-Fi) speed and strength for each detected wireless communication signal (e.g., wireless local area network (LAN) signal). The UV may create a map of the indoor space and predict its location in the map using visual simultaneous localization and mapping (SLAM) techniques and object detection techniques. In one embodiment, the UV may repeat the video and wireless signal capturing/measuring process at each location of the indoor space and transmit the data to a server for further processing. The network optimization program running on the server may create a visual two-dimensional (2D) map of the indoor space by concatenating scenes from the video of the indoor space received from the UV. If the quality of the wireless signal (e.g., slow wireless network speed, unavailable signal) is low (e.g., below a network performance threshold), the network optimization program may predict one or more reasons for the low wireless signal quality from the video and wireless signal data received from the UV. The network optimization program may generate a wireless signal map using the 2D map and indicate any locations with low wireless signal quality linked to the reasons for the low wireless signal quality.

According to one embodiment, if the network optimization program detects low wireless signal quality and identifies multiple overlapping wireless signals on the same frequency channel, the network optimization program may predict the root cause of the low wireless signal quality as being radio wave interference. In one embodiment, the network optimization program may suggest relocating the LAN devices (e.g., wireless access points) away from each other and/or selecting a different frequency channel.

However, if the network optimization program does not identify multiple overlapping wireless signals on the same frequency channel, the network optimization program may predict that the root cause for the low wireless signal quality is a weak wireless signal received from the wireless access point. In one embodiment, the network optimization program may use video data to further predict the underlying reasons for the weak wireless signal (e.g., physical obstruction, wireless access point is too far). In one embodiment, the network optimization program may suggest the optimal location for LAN devices and/or suggest installing additional LAN devices. in one embodiment, the optimal locations for additional LAN devices may also be suggested.

Additionally, or alternatively, if the video data from the UV indicates many people and/or electronic devices in the location of the low wireless signal quality, the network optimization program may predict overcapacity of the network or wireless access points as the root cause for the low wireless signal quality. In one embodiment, the network optimization program may suggest reviewing the number of connected users/devices and extending the number and/or capacity if the LAN devices.

In one embodiment, the network optimization program may predict multiple root causes for the low wireless signal quality (e.g., radio interference and overcapacity). In at least one embodiment, if the above root causes do not apply to the low wireless signal quality, the server may predict that the settings of the wireless network or wireless access point may be the reasons for the low wireless signal quality.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

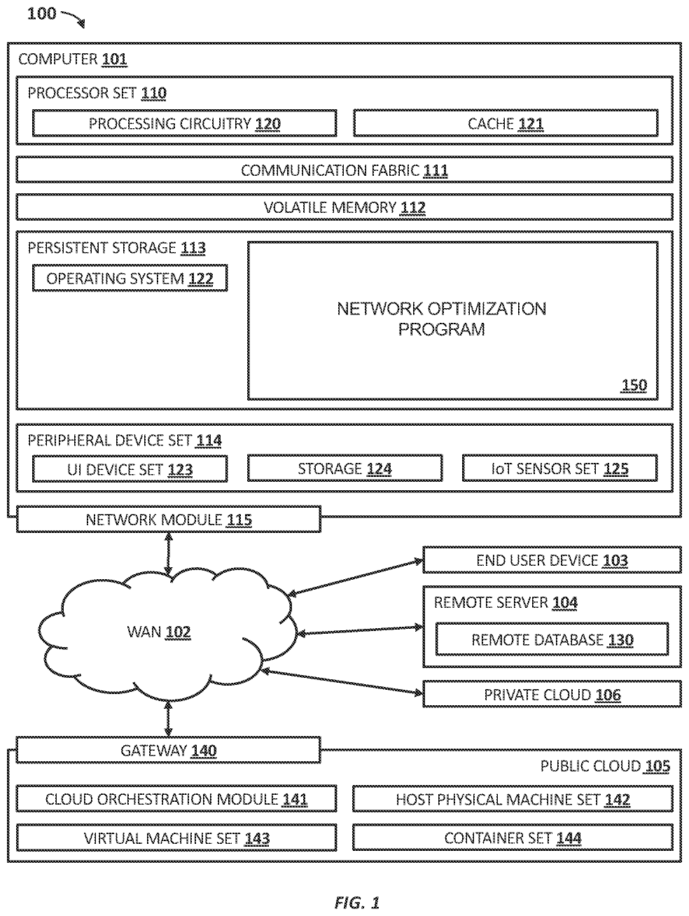

Referring to FIG. 1, a computing environment 100 according to at least one embodiment is depicted. Computing environment 100 contains an example of an environment for the execution of at least some of the computer code involved in performing the inventive methods, such as network optimization program 150. In addition to network optimization program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and network optimization program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Furthermore, despite only being depicted in computer 101, network optimization program 150 may be stored in and/or executed by, individually or in any combination, EUD 103, remote server 104, public cloud 105, and private cloud 106.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The network optimization program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of Bluetooth SIG, Inc. and/or its affiliates) connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way. EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, a user using any combination of an EUD 103, remote server 104, public cloud 105, and private cloud 106 may use the network optimization program 150 to provide continuous monitoring and visualization of real-time wireless network availability and unavailability in a three-dimensional space, including predicted root causes, and troubleshooting for any wireless network unavailability.

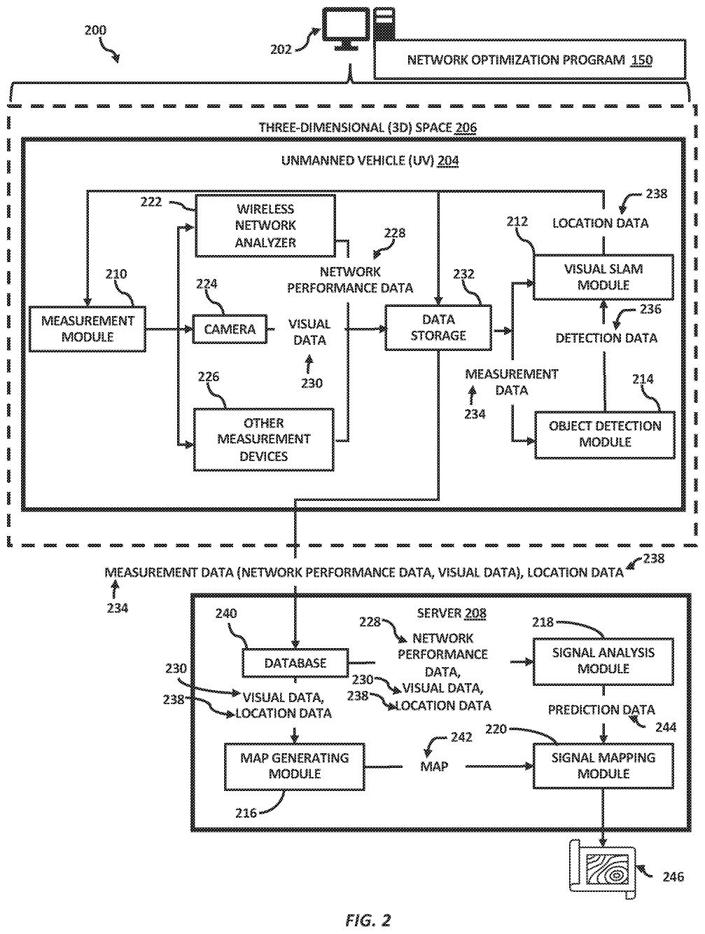

Embodiments of the present disclosure are explained in more detail below with respect to FIGS. 2 to 4.

Referring now to FIG. 2, a schematic block diagram of a network optimization environment 200 according to at least one embodiment is depicted. According to one embodiment, the network optimization environment 200 may include a computer system 202 having a tangible storage device and a processor that is enabled to run the network optimization program 150.

Generally, the computer system 202 may be enabled by the network optimization program 150 to implement a moving sensor, such as, for example, an unmanned vehicle (UV) 204, to move through a three-dimensional (3D) space 206. In one embodiment, UV 204 may be enabled by the network optimization program 150 to traverse (e.g., via air and/or land) the 3D space 206 autonomously, without navigational control from a user. 3D space 206 may include an indoor space (e.g., building), an outdoor space (e.g., city streets), and/or a combination of indoor and outdoor spaces.

According to one embodiment, the computer system 202 may include one or more components (e.g., computer 101; end user device (EUD) 103; WAN 102) of the computer environment 100 described above with reference to FIG. 1. In one embodiment, the computer system 202 may include one or more computers (e.g., computer 101) which may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, and/or querying a database.

According to one embodiment, UV 204 of computer system 202 may include computer 101. In one embodiment, computer system 202 may also include a server 208 that is similar to remote server 104 described with reference to FIG. 1. In at least one embodiment, aspects of the computer system 202 may operate in a cloud computing service model, such as Software as a Service (SaaS), Platform as a Service (PaaS), or Infrastructure as a Service (IaaS). In one embodiment, the computer system 202 may also be implemented as a cloud computing deployment model, such as a private cloud, community cloud, public cloud, or hybrid cloud.

In one embodiment, the network optimization program 150 may include a single computer program or multiple program modules or sets of instructions being executed by the processor of the computer system 202 (e.g., UV 204, server 208). In one embodiment, the network optimization program 150 may include routines, objects, components, units, logic, data structures, and actions that may perform particular tasks or implement particular abstract data types. In one embodiment, the network optimization program 150 may be practiced in distributed cloud computing environments where tasks may be performed by local and/or remote processing devices which may be linked through a communication network (e.g., WAN 102).

According to one embodiment, the network optimization program 150 may include a measurement module 210, a visual SLAM module 212, an object detection module 214, a map generating module 216, a signal analysis module 218, and a signal mapping module 220. In one embodiment, the network optimization program 150 may implement the measurement module 210, the visual SLAM module 212, and the object detection module 214 using UV 204, and may implement the map generating module 216, the signal analysis module 218, and the signal mapping module 220 using server 208. However, in one embodiment, the network optimization program 150 (e.g., the various modules) may be executed on a single computing device (e.g., UV 204).

According to one embodiment, the UV 204 may include various onboard sensors such as, a wireless network analyzer 222, one or more cameras 224, and other measurement devices 226 (e.g., GPS, light detection and ranging (Lidar) sensors, depth sensors, inertial sensors). The network optimization program 150 may implement UV 204 to survey 3D space 206, which may be previously unknown, and therefore not mapped (e.g., no pre-existing map) by the network optimization program 150. As such, the network optimization program 150 may implement the wireless network analyzer 222 to measure the wireless signals detected in the 3D space 206 and may simultaneously implement the camera 224 and other measurement devices 226 for mapping and navigation. More specifically, the measurement module 210 of the network optimization program 150 may instruct the wireless network analyzer 222 to collect and record network performance data 228 at various locations in the 3D space 206. In one embodiment, the network performance data 228 may include a measurement of the wireless signal strength (e.g., power level of the signal) in decibel milliwatts (dBm). In one embodiment, the wireless signal strength may be measured and recorded as signal bars, where four bars may indicate the highest signal strength and zero bars may indicate no signal. Simultaneously, the measurement module 210 may implement the camera 224 to capture and record visual data 230 of the 3D space 206. Visual data 230 may include a sequence of images or video of the 3D space 206 at each location. In one embodiment, UV 204 may include onboard data storage 232 for storing measurement data 234. In one embodiment, the measurement data 234 may include the network performance data 228 and the visual data 230 linked to a unique location identifier corresponding to each location analyzed by UV 204. In some embodiments, the measurement data 234 stored in data storage 232 may also include any data captured by the other measurement devices 226.

According to one embodiment, the object detection module 214 and the visual SLAM module 212 may retrieve the measurement data 234 from data storage 232 to map of the 3D space 206 and predict the location of the UV 204 in the map of the 3D space 206. The object detection module 214 may segment the features in the visual data 230 to identify and recognize features in the environment of the 3D space 206. The object detection module 214 may output detection data 236 which may be used by the visual SLAM module 212. In one embodiment, the visual SLAM module 212 may use the detection data 236 to detect and track landmarks as reference points in the 3D space 206. The visual SLAM module 212 may use the landmarks to map the unknown 3D space 206 while also localizing the position of the UV 204. In one embodiment, the visual SLAM module 212 may output location data 238 which may be stored in data storage 232 (e.g., as the unique location identifier) and also transmitted back to the measurement module 210. The network optimization program 150 may implement the measurement module 210 to repeat the video (e.g., visual data 230) and wireless signal (e.g., network performance data 228) capturing/measuring process at each location of the 3D space 206. The network optimization program 150 may implement the object detection module 214 and the visual SLAM module 212 to update the map and track the location of the UV 204 as new visual data 230 is captured.

According to one embodiment, the network optimization program 150 may transmit the measurement data 234 (e.g., including network performance data 228 and visual data 230) and the location data 238 to server 208 for further processing. Initially, the measurement data 234 (e.g., including network performance data 228 and visual data 230) and the location data 238 may be stored in a database 240 of the server 208. In one embodiment, the map generating module 216 of the network optimization program 150 may retrieve/receive the visual data 230 and the location data 238 from database 240 and construct a visual two-dimensional (2D) map 242 of the 3D space 206. In one embodiment, the map generating module 216 may concatenate scenes of the 3D space 206 depicted in the visual data 230 to construct the 2D map 242.

According to one embodiment, the signal analysis module 218 may retrieve/receive the network performance data 228, visual data 230, and the location data 238 to detect whether any locations in the 3D space 206 includes weak wireless signals. In one embodiment, the network optimization program 150 may set or enable a user to set, a network performance scale ranging from excellent network performance (e.g., strong wireless signal) to weak network performance (e.g., weak or no wireless signal). For example, the network performance scale may include excellent network performance, good network performance, fair network performance, and weak network performance. Each category (e.g., excellent, good, fair, weak) may be defined by a range of signal strength dBm units. In one embodiment, a network performance threshold may be set where below-threshold network performance (e.g., signal strengths below a set dBM) may indicate signal strengths in the weak network performance category. In at least one embodiment, below-threshold network performance may also be set to include signal strength in the fair network performance category. Thus, the signal analysis module 218 may determine whether any of the network performance data 228 falls in the below-threshold network performance category. If the network performance data 228 is not measured in a certain location, the network optimization program 150 may interpolate (e.g., predict) the network performance data 228 at that location based on the network performance of the surrounding locations. If any of the locations is determined to include below-threshold network performance (e.g., slow wireless network) based on the network performance data 228, the signal analysis module 218 may output prediction data 244 that indicates a root cause for the below-threshold network performance and provides troubleshooting steps to improve the network performance.

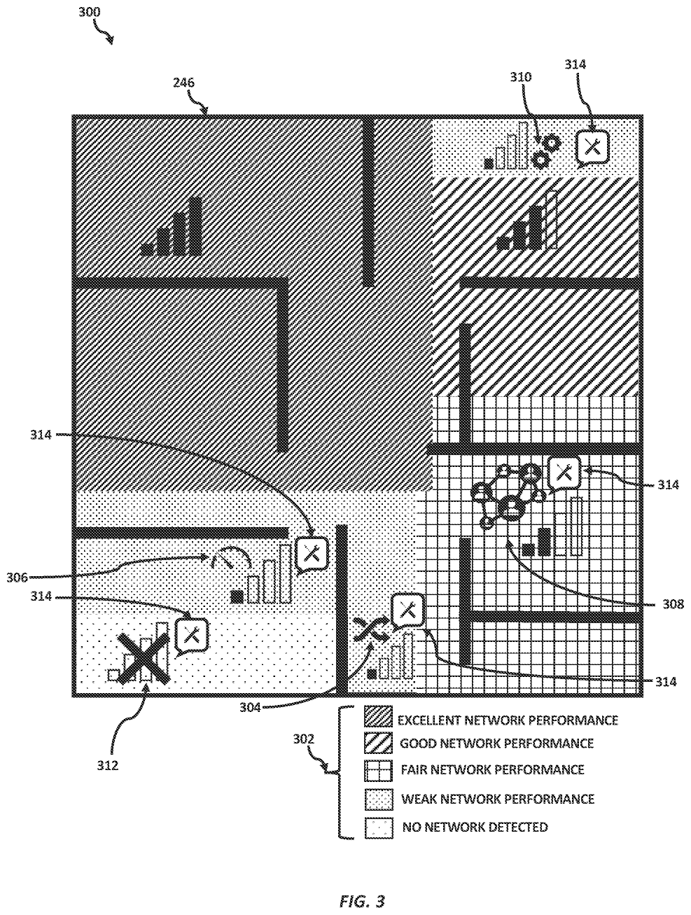

According to one embodiment, the signal mapping module 220 of the network optimization program 150 may merge the 2D map 242 of the 3D space 206 and the prediction data 244 to generate a network performance map 246 associated with the 3D space 206. One embodiment of the network performance map 246 (e.g., wireless signal map) is described with reference to FIG. 3, below.

Referring now to FIG. 3, a schematic block diagram of a network optimization GUI 300 according to at least one embodiment is depicted. In one embodiment, the GUI 300 may include the network performance map 246 generated by the signal mapping module 220 of the network optimization program 150. In one embodiment, the network performance map 246 may include the 2D map 242 overlayed with a graphical representation of the prediction data 244. In one embodiment, the network performance data 228 corresponding to the respective locations of the 3D space 206 may be indicated using distinct colors or pattern fills 302 as illustrated in FIG. 3.

According to one embodiment, the network optimization program 150 may graphically mark the network performance map 246 to indicate the locations including below-threshold network performance. For example, a first indicator 304 may be generated to graphically mark a first location including below-threshold network performance. In one embodiment, the first indicator 304 may also graphically indicate a predicted root cause for the below-threshold network performance. For example, the first indicator 304 may represent an icon for radio wave interference.

Similarly, a second indicator 306 may be generated to graphically mark a second location including the below-threshold network performance. In one embodiment, the second indicator 306 may also graphically indicate a predicted root cause for the below-threshold network performance. For example, the second indicator 306 may represent an icon for weak wireless signal. Similarly, a third indicator 308 may be marked in a third location and represent an icon for overcapacity of the network as the root cause for the below-threshold network performance. A fourth indicator 310 may be marked in a fourth location and represent an icon for wireless network settings as the root cause for the below-threshold network performance. A fifth indicator 312 may be marked in a fifth location and represent an icon for no network detected as the root cause for the below-threshold network performance. In addition to marking the locations with below-threshold network performance and indicating the predicted root causes, the network performance map 246 may also provide remedies (e.g., troubleshooting steps), as marked by a sixth indicator 314 at each marked location, to cure the network performance issues. In one embodiment, the user may select the sixth indicator 314 to view the suggested troubleshooting steps. According to one embodiment, the network optimization program 150 may update the network performance map 246 in real-time as the UV 204 surveys the 3D space 206.

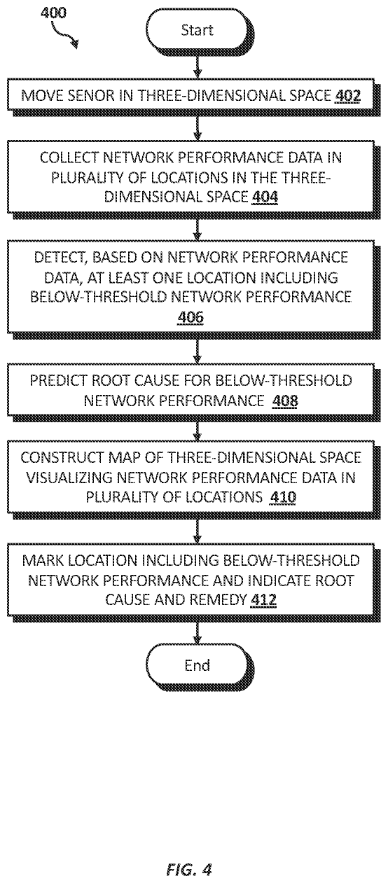

Referring now to FIG. 4, an operational flowchart illustrating an exemplary process 400 used by the network optimization program 150 according to at least one embodiment is depicted. FIG. 4 provides a description of process 400 with reference to the network optimization environment 200 (FIG. 2) and the network optimization GUI 300 (FIG. 3).

At 402, a sensor is moved in a 3D space. According to one embodiment, the network optimization program 150 may implement an autonomously moving sensor (e.g., unmanned vehicle (UV)) to survey a physical 3D space. As described with reference to FIG. 2, the 3D space may be previously unknown to the network optimization program 150 such that pre-existing maps of the 3D space does not exist.

Then at 404, network performance data is collected in a plurality of locations in the 3D space. According to one embodiment, the network optimization program 150 may implement a wireless network analyzer onboard the UV to measure and record the wireless signal strength for each detected wireless network signal in the 3D space. As described previously with reference to FIG. 2, in addition to the network performance data, the network optimization program 150 may also implement the cameras onboard the UV to capture visual data depicting the 3D space.

Then at 406, at least one location including below-threshold network performance is detected. According to one embodiment, the network optimization program 150 may provide a wireless signal strength threshold (e.g., in dBm units) and detect those wireless signals that fall below the threshold as including below-threshold network performance.

Then at 408, a root cause for below-threshold network performance is predicted. As described previously with reference to FIG. 2, if the quality of the wireless signal (e.g., slow wireless network speed, unavailable signal) is low (e.g., below a network performance threshold), the network optimization program 150 may predict one or more reasons for the low wireless signal quality using the visual data and network performance data received from the UV.

Then at 410, a map of the 3D space visualizing the network performance data in the plurality of locations is constructed. According to one embodiment, the network optimization program 150 may generate a 2D map of the 3D space by concatenating scenes from the visual data of the 3D space received from the UV. In one embodiment, the network optimization program 150 may construct a network performance map by overlaying the 2D map of the 3D space with a graphical representation of the prediction data generated by the network optimization program 150, as described previously with reference to FIGS. 2 and 3. In one embodiment, the network performance data corresponding to the respective locations of the 3D space may be indicated using distinct colors or pattern fills (FIG. 3).

Thereafter at 412, locations including below-threshold network performance are marked and root causes and remedies are graphically indicated. As described previously with reference to FIG. 3, the network optimization program 150 may graphically mark the network performance map to indicate the locations including below-threshold network performance. Each of the marked locations may include a representative icon indicating the root cause for the below-threshold network performance. Further, the network performance map may also provide specific remedies (e.g., troubleshooting steps) to the network performance issues, as marked by another set of indicators at each marked location. In one embodiment, the user may select the remedy indicator to view the suggested troubleshooting steps.

It is contemplated that the network optimization program 150 may provide several advantages and/or improvements to the technical field of wireless communication networks. The network optimization program 150 may also improve the functionality of a computer because the network optimization program 150 may enable the computer to autonomously capture and analyze wireless signals. The network optimization program 150 may also improve the functionality of a computer by enabling the computer to provide a GUI that can visualize the wireless signal quality in a three-dimensional space and indicate any locations with weak wireless signals, resulting in below-threshold network performance. The network optimization program 150 may further enable the computer to predict the root cause for the below-threshold network performance, and provide troubleshooting steps to improve the network performance.

It may be appreciated that FIGS. 2 to 4 provide only an illustration of one embodiment and do not imply any limitations with regard to how different embodiments may be implemented. Many modifications to the depicted embodiment(s) may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
moving a sensor in a three-dimensional space;
collecting, using the sensor, network performance data in a plurality of locations in the three-dimensional space;
detecting, based on the network performance data, at least one location of the plurality of locations including below-threshold network performance; and
predicting at least one root cause for the below-threshold network performance at the at least one location.

2. The computer-implemented method of claim 1, further comprising:
collecting, using the sensor moving in the three-dimensional space, visual data associated with the three-dimensional space;
constructing a map of the three-dimensional space using the visual data; and
indicating, in the map of the three-dimensional space, the network performance data associated with the plurality of locations in the three-dimensional space.

3. The computer-implemented method of claim 2, further comprising:
marking, in the map of the three-dimensional space, the at least one location of the plurality of locations including the below-threshold network performance; and
indicating, in the map of the three-dimensional space, the at least one root cause predicted for the below-threshold network performance at the at least one location.

4. The computer-implemented method of claim 3, further comprising:
determining at least one remedy for the below-threshold network performance at the at least one location based on the at least one root cause predicted for the below-threshold network performance; and
indicating, in the map of the three-dimensional space, the at least one remedy for the below-threshold network performance at the at least one location.

5. The computer-implemented method of claim 2, wherein the at least one root cause for the below-threshold network performance at the at least one location is predicted based on the network performance data and the visual data associated with the at least one location.

6. The computer-implemented method of claim 2, wherein the map of the three-dimensional space includes a two-dimensional map that is overlayed with the network performance data associated with the plurality of locations in the three-dimensional space.

7. The computer-implemented method of claim 3, wherein the at least one root cause is indicated in the map using a representative graphical icon.

8. A computer system for network optimization, comprising:
one or more processors, one or more computer-readable memories, one or more computer-readable tangible storage media, and program instructions stored on at least one of the one or more computer-readable tangible storage media for execution by at least one of the one or more processors via at least one of the one or more memories, wherein the computer system is capable of performing a method comprising:
moving a sensor in a three-dimensional space;
collecting, using the sensor, network performance data in a plurality of locations in the three-dimensional space;
detecting, based on the network performance data, at least one location of the plurality of locations including below-threshold network performance; and
predicting at least one root cause for the below-threshold network performance at the at least one location.

9. The computer system of claim 8, further comprising:
collecting, using the sensor moving in the three-dimensional space, visual data associated with the three-dimensional space;
constructing a map of the three-dimensional space using the visual data; and
indicating, in the map of the three-dimensional space, the network performance data associated with the plurality of locations in the three-dimensional space.

10. The computer system of claim 9, further comprising:
marking, in the map of the three-dimensional space, the at least one location of the plurality of locations including the below-threshold network performance; and
indicating, in the map of the three-dimensional space, the at least one root cause predicted for the below-threshold network performance at the at least one location.

11. The computer system of claim 10, further comprising:
determining at least one remedy for the below-threshold network performance at the at least one location based on the at least one root cause predicted for the below-threshold network performance; and
indicating, in the map of the three-dimensional space, the at least one remedy for the below-threshold network performance at the at least one location.

12. The computer system of claim 9, wherein the at least one root cause for the below-threshold network performance at the at least one location is predicted based on the network performance data and the visual data associated with the at least one location.

13. The computer system of claim 9, wherein the map of the three-dimensional space includes a two-dimensional map that is overlayed with the network performance data associated with the plurality of locations in the three-dimensional space.

14. The computer system of claim 10, wherein the at least one root cause is indicated in the map using a representative graphical icon.

15. A computer program product for network optimization, comprising:
one or more computer-readable storage media and program instructions collectively stored on the one or more computer-readable storage media, the program instructions executable by a processor to cause the processor to perform a method comprising:
moving a sensor in a three-dimensional space;
collecting, using the sensor, network performance data in a plurality of locations in the three-dimensional space;
detecting, based on the network performance data, at least one location of the plurality of locations including below-threshold network performance; and
predicting at least one root cause for the below-threshold network performance at the at least one location.

16. The computer program product of claim 15, further comprising:
collecting, using the sensor moving in the three-dimensional space, visual data associated with the three-dimensional space;
constructing a map of the three-dimensional space using the visual data; and
indicating, in the map of the three-dimensional space, the network performance data associated with the plurality of locations in the three-dimensional space.

17. The computer program product of claim 16, further comprising:
marking, in the map of the three-dimensional space, the at least one location of the plurality of locations including the below-threshold network performance; and
indicating, in the map of the three-dimensional space, the at least one root cause predicted for the below-threshold network performance at the at least one location.

18. The computer program product of claim 17, further comprising:
determining at least one remedy for the below-threshold network performance at the at least one location based on the at least one root cause predicted for the below-threshold network performance; and
indicating, in the map of the three-dimensional space, the at least one remedy for the below-threshold network performance at the at least one location.

19. The computer program product of claim 16, wherein the at least one root cause for the below-threshold network performance at the at least one location is predicted based on the network performance data and the visual data associated with the at least one location.

20. The computer program product of claim 16, wherein the map of the three-dimensional space includes a two-dimensional map that is overlayed with the network performance data associated with the plurality of locations in the three-dimensional space.
